(19) United States
(12) Patent Application Publication
(10) Pub. No.: US 2008/0192625 A1
(43) Pub. Date: Aug. 14, 2008

(54) REDUNDANT SWITCHING SYSTEM, REDUNDANT SWITCHING METHOD AND RECORDING MEDIUM

(76) Inventor: YOSHIAKI AONO, Tokyo (JP)

Correspondence Address: NEC CORPORATION OF AMERICA, 6535 N. STATE HWY 161, IRVING, TX, 75039, US

(21) Appl. No.: 12/021,579

(22) Filed: Jan. 29, 2008

(30) Foreign Application Priority Data
Feb. 13, 2007 (JP) 2007-032205

(51) Int. Cl. G06F 11/00

(52) U.S. Cl. 370/225

(57) ABSTRACT

The present invention provides a redundant switching system capable of continuing to construct an uninterrupted redundant configuration. The redundant switching system 100 includes at least two pathways (e.g. pathways 10-1 and 10-2) that construct an uninterrupted redundant configuration, and allow uninterrupted pathway switching. In the event that a failure occurs in either (pathway 10-1) of the two pathways (10-1 and 10-2), another pathway (pathway 10-3) allowing uninterrupted pathway switching for the pathway (pathway 10-2) where a failure did not occur is prepared. Then an uninterrupted redundant configuration is reconstructed by means of the pathway where a failure did not occur (pathway 10-2) and the other pathway (pathway 10-3).

This application is based upon and claims the benefit of priority from Japanese patent application No. 2007-032205, filed on Feb. 13, 2007, the disclosure of which is incorporated herein in its entirety by reference.

### BACKGROUND OF THE INVENTION

The present invention pertains to a redundant switching system, a redundant switching method and a recording medium for recording a redundant switching program, and more particularly, to a redundant switching system, a redundant switching method and a recording medium for performing uninterrupted pathway switching.

### DESCRIPTION OF RELATED ART

A suggestion has been made to prevent the occurrence of the failure or the like from having an impact on the quality of the transmission, in the event that a failure or the like occurs in a transmission pathway in a transmission system. FIG. 7 shows an example of a system configuration that allows uninterrupted switching in the transmission system. The uninterrupted pathway switching related to the present invention will be described below with reference to FIGS. 7(a), (b) and (c).

As shown in FIG. 7(a), a transmission system 300 has transmitters 304 and 305, pathways 301 and 302, receivers 306 and 307, and a selector 309. In the example of FIG. 7(a), an active system includes the transmitter 304, the pathway 301, the receiver 306, and a redundant system includes the transmitter 305, the pathway 302 and the receiver 307.

The active system and the redundant system transmit branched signals 1 and 2 that have the same information. These signals 1 and 2 are sent from the transmitters 304 and 305, transmitted through the pathways 301 and 302, and received by the receivers 306 and 307. Then, the signals 1 and 2 are phase-adjusted at the receivers 306 and 307, and either of the signals is selected and outputted by the selector 309. This allows for uninterrupted switching from the active system to the redundant system. Note that, under normal conditions, the selector 309 selects and outputs the signal 1 that transmits through the pathway 301 of the active system, as shown in FIG. 7(a). As shown in FIG. 7(b), in the event that a failure occurs in the pathway 301 of the active system, the transmission is uninterruptedly switched from the active system to the redundant system. Therefore, as shown in FIG. 7(b), the selector 309 selects and outputs the signal 2 that transmits through the pathway 302 of the redundant system.

In this manner, the above described transmission system 300 has the pathway 301 as the active system, and the pathway 302 as the redundant system, and performs uninterrupted switching between the predetermined two pathways. Consequently, as shown in FIG. 7(c), in the event that a failure occurs in both the pathways 301 and 302, there is no method for rescuing the system. Accordingly, the above described transmission system 300 cannot maintain an uninterrupted redundant configuration.

For this reason, in Patent Document 1 (Japanese Patent Laid Open Publication No. 7-95207), a suggestion has been made that uninterrupted path relocation is performed according to changes in the structure of a communication network and changes in the demand of communication service. In this suggestion, according to changes in a structure of a communication network and changes in a demand of communication service, a new pathway most suitable for the path is calculated, and uninterrupted path switching to the most suitable pathway is performed.

However, in the suggestion in Patent Document 1, there is a problem that the path cannot be switched to the most suitable pathway when the communication network does not have a mesh structure. Further, there is a problem that, in the event that a failure occurs immediately also in the backup pathway to which uninterrupted switching has been performed, this suggestion cannot address this failure. In other words, in the above described Patent Document 1, it is difficult to maintain an uninterrupted redundant configuration.

Moreover, in such a configuration of Patent Document 1, there is a problem that complex control is required because the switching of connection paths must be controlled by one controller with respect to a plurality of communication nodes. In addition, there is a problem that more complex control is required because when several controllers control the communication nodes on the system, the controllers have to work together to control the plurality of communication nodes.

### SUMMARY OF THE INVENTION

An exemplary object of the invention is to provide a redundant switching system, a redundant switching method and a recording medium that can continue to construct an uninterrupted redundant configuration in order to solve the above described problem.

In order to achieve such an object, the present invention has the following characteristics.

### <Redundant Switching System>

A redundant switching system according to an exemplary aspect of the invention comprises at least two pathways that construct an uninterrupted redundant configuration, and allow uninterrupted pathway switching, wherein in the event that a failure occurs in either of the two pathways, the system prepares another pathway allowing uninterrupted pathway switching for the pathway where a failure did not occur to reconstruct an uninterrupted redundant configuration by means of the pathway where a failure did not occur and the other pathway.

Further, a redundant switching system according to an exemplary aspect of the invention comprises at least a first pathway for transmitting a first signal, and a second pathway that allows uninterrupted pathway switching for the first pathway and transmits a second signal that contains the same information as that of the first signal, wherein in the event that a failure occurs in the first pathway, the system performs uninterrupted pathway switching to the second pathway, and prepares a third pathway allowing uninterrupted pathway switching for the second pathway.

### <Redundant Switching Method>

Further, a redundant switching method according to an exemplary aspect of the invention is a redundant switching method in a transmission system, comprising: constructing an uninterrupted redundant configuration by means of two pathways allowing uninterrupted pathway switching; and in the event that a failure occurs in either of the two pathways, preparing another pathway allowing uninterrupted pathway switching for the pathway where a failure did not occur to reconstruct an uninterrupted redundant configuration by means of the pathway where a failure did not occur and the other pathway.

Further, a redundant switching method according to an exemplary aspect of the invention is a redundant switching method in a transmission system, comprising: transmitting a first signal through a first pathway; transmitting a second signal that contains the same information as that of the first signal through a second pathway allowing uninterrupted pathway switching for the first pathway; retaining uninterrupted redundancy by means of the first signal received through the first pathway and the second signal received through the second pathway; in the event that a failure occurs in the first pathway, preparing a third pathway allowing uninterrupted pathway switching for the second pathway; transmitting the second signal through the second pathway; transmitting the first signal through the third pathway instead of the second pathway; and restoring retention of uninterrupted redundancy by means of the second signal received from the second pathway and the first signal received from the third pathway.

### <Recording Medium for Recording Redundant Switching Program>

Further, a recording medium according to an exemplary aspect of the invention is a computer readable recording medium on which a redundant switching program is recorded in a transmission system, causing a computer to: construct an uninterrupted redundant configuration by means of two pathways allowing uninterrupted pathway switching; in the event that a failure occurs in either of the two pathways, prepare another pathway allowing uninterrupted pathway switching for the pathway where a failure did not occur to reconstruct an uninterrupted redundant configuration by means of the pathway where a failure did not occur and the other pathway.

### BRIEF DESCRIPTION OF THE DRAWINGS

The objects and features of the present invention will become more apparent from the consideration of the following detailed description taken in conjunction with the accompanying drawings, in which:

FIG. 1 is a diagram showing an example of a system configuration of a redundant switching system according to a first exemplary embodiment;

FIG. 2 is a diagram showing a normal operation condition;

FIG. 3 is a diagram showing a condition where a transmission path failure occurs in an active pathway;

FIG. 4 is a diagram showing a condition where a new redundant configuration is constructed;

FIG. 5 is a diagram showing processing operation of a redundant switching system;

FIG. 6 is a diagram showing an example of a system configuration of a redundant switching system according to a second exemplary embodiment; and

FIG. 7 is a diagram showing a redundant switching method related to the present invention, (a) being a diagram showing an example of a configuration that allows uninterrupted pathway switching, (b) being a diagram showing a case where a failure occurs in an active pathway, and (c) being a diagram showing a case where a failure occurs also in a redundant pathway.

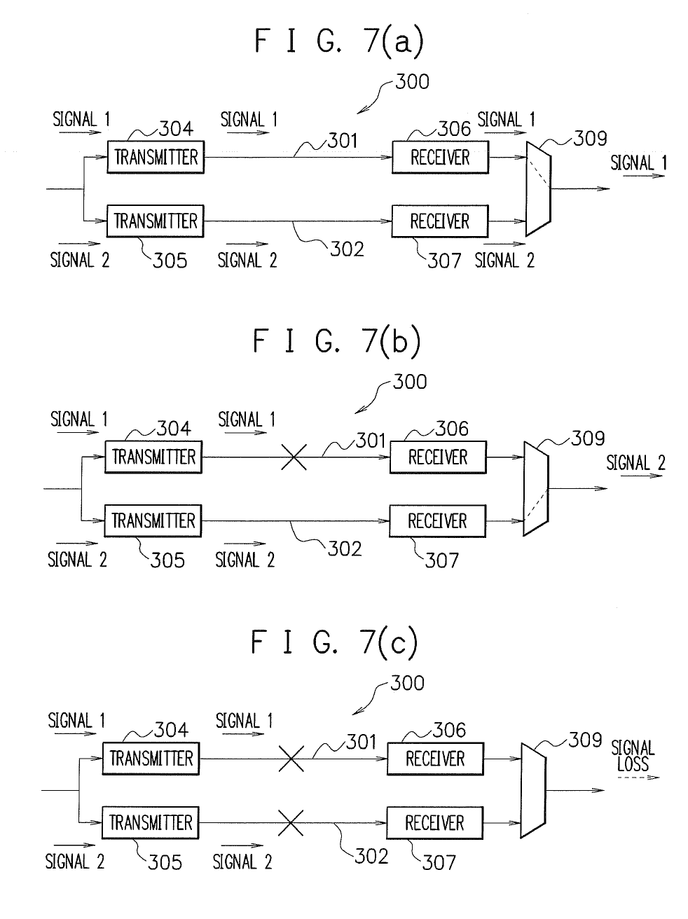

### DESCRIPTION OF EXEMPLARY EMBODIMENTS

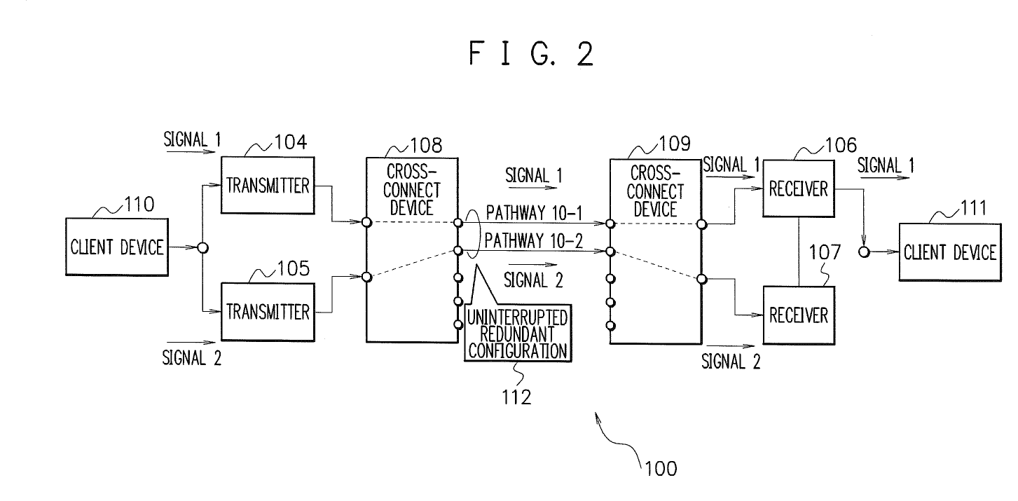

First, the overview of a redundant switching system in exemplary embodiments will be described with reference to FIGS. 2 to 4.

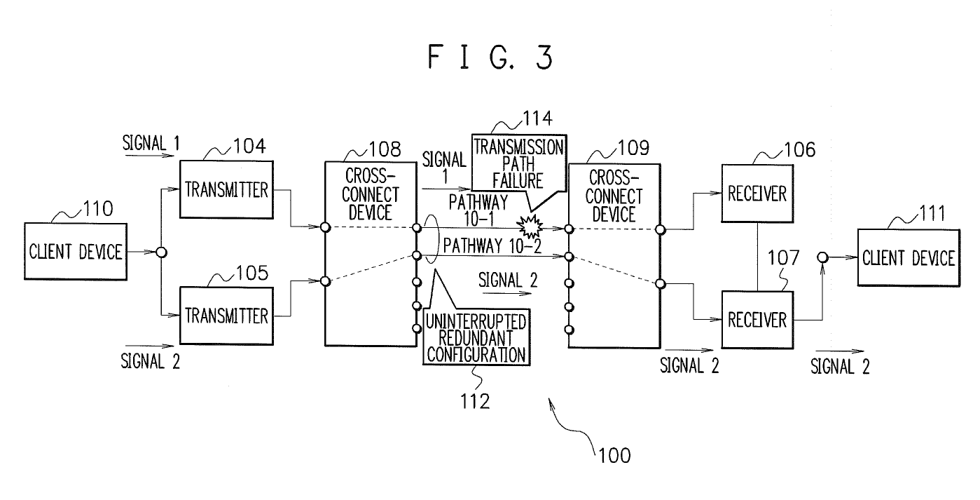

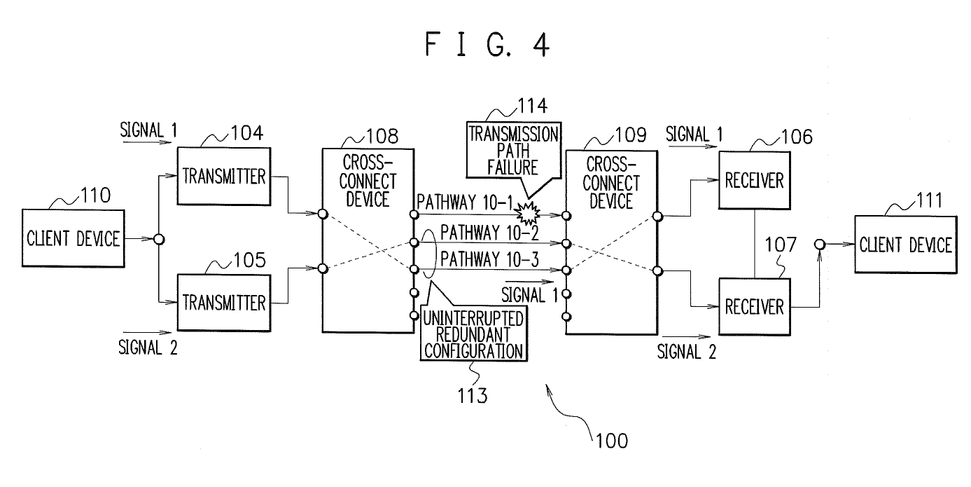

The redundant switching system includes at least two pathways (e.g. pathways 10-1 and 10-2) that construct an uninterrupted redundant configuration, and allow uninterrupted pathway switching, as shown in FIG. 2. In the event that a failure occurs in either (for example, pathway 10-1) of the two pathways (10-1 and 10-2) as shown in FIG. 3, the redundant switching system prepares another pathway (pathway 10-3) allowing uninterrupted pathway switching to the pathway (pathway 10-2) where a failure did not occur, as shown in FIG. 4. Then the redundant switching system reconstructs an uninterrupted redundant configuration by means of the pathway where a failure did not occur (pathway 10-2) and the other pathway (pathway 10-3). This can maintain an uninterrupted redundant configuration. The redundant switching system of exemplary embodiments will be described below in detail with reference to accompanying drawings.

### First Exemplary Embodiment

### Redundant Switching System

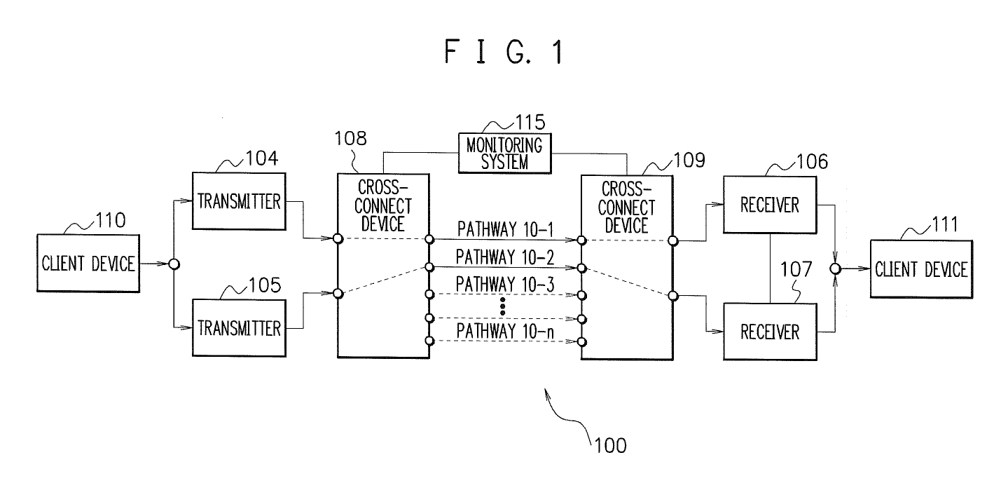

First, an example of the system configuration of a redundant switching system of the present exemplary embodiment will be described with reference to FIG. 1. FIG. 1 is a diagram showing an example of the system configuration of the redundant switching system according to the present exemplary embodiment.

A redundant switching system 100 of the present exemplary embodiment includes transmitters 104 and 105, pathways 10-1 to 10-n (n is any integer equal to or more than three), receivers 106 and 107, and cross-connect devices 108 and 109. The redundant switching system 100 performs transmission between a client device 110 and a client device 111, which are external devices.

The transmitters 104 and 105 receive branched signals 1 and 2 sent from the client device 110, and output the signals to the cross-connect device 108. Each of the transmitters 104 and 105 adds a counter number for signal phase adjustment to the signals 1 and 2, which were entered by the client device 110, and outputs the signals to the cross-connect device 108. This allows the signals 1 and 2 outputted from the transmitters 104 and 105 to be kept in the same phase. The counter number is inserted into an overhead of the Optical Transport Network (OTN) (defined in ITU-T G. 709) or the Synchronous Optical Network (Sonet)/Synchronous Digital Hierarchy (SDH), or a space area of the Multi Protocol Label Switching (MPLS) label. Note that, when the counter number has already been inserted by the client device 110, the transmitters 104 and 105 do not insert another counter number, and use the counter number inserted by the client device 110. Various types of configuration and means may be used for the branches from the client device 110 to the transmitters 104 and 105; for example, the branches can include a coupler, a circuit or the like.

Note that the signals 1 and 2 include the same information. Further, when the transmitters 104 and 105 are optical transmitters, the signals 1 and 2 outputted from the transmitters 104 and 105 are optical signals. Note that the signals 1 and 2 outputted from the client device 110 may be optical signals or electrical signals. When the signals 1 and 2 are electrical signals, the transmitters 104 and 105 have an electrical-to-optical conversion function. On the other hand, when the signals 1 and 2 are optical signals, the transmitters 104 and 105 have a wavelength conversion function or a bit rate conversion function, as needed. For example, when Wavelength Division Multiplexing (MDW) transmission is performed for large-capacity transmission, the transmitters 104 and 105 convert the wavelength of the signal to a wavelength assigned to each transmitter. Moreover, when the counter number for signal phase adjustment or the overhead for monitoring is added, the bit rate is raised. The transmitters 104 and 105 send the signals 1 and 2 to the cross-connect device 108.

The cross-connect device 108 allocates the two signals 1 and 2 to the pathways 10-1 to 10-n, and outputs the signals. The pathways 10-1 to 10-n transmit the signals 1 and 2, respectively. The cross-connect device 109 allocates the signals, which were received from the pathways 10-1 to 10-n, to the receivers 106 and 107, and outputs the signals. Since the cross-connect devices 108 and 109 perform uninterrupted pathway switching at this moment, the cross-connect devices 108 and 109 have to synchronize with each other at transmitting/receiving terminals for selecting a pathway. A pathway search and a pathway setting by the cross-connect devices 108 and 109 can be performed by a manual setting or an automatic setting. The manual setting can be set by manual operation using a monitoring system 115. Meanwhile, the automatic setting can be performed using the Generalized Multi Protocol Label Switching (GMPLS), or the Multi Protocol Label Switching (MPLS). Note that, since the functions of the GMPLS and MPLS are well known to one of ordinary skill in the art, the detailed description of the configuration will be omitted herein. Although the cross-connect devices 108 and 109 may be an optical cross-connect device or an electric cross-connect device, depending on the volume and type of a signal to be handled, both devices may be applicable to the redundant switching system of the present exemplary embodiment. Note that, when the signals 1 and 2 transmitted through the pathways 10-1 to 10-n are optical signals, the cross-connect devices 108 and 109 are the optical cross-connect devices. In this case, since the signals 1 and 2 do not have to be converted into electricity, fast switching is possible.

The pathways 10-1 to 10-n connect the cross-connect device 108 to the cross-connect device 109, and transmit signals between them. In the example of FIG. 1, the pathway 10-1 is used as an active pathway, and the pathway 10-2 is used as a redundant pathway. The pathway 10-3 is a new pathway prepared by the cross-connect devices 108 and 109 in the event that a failure occurs in the pathway 10-1 or 10-2. Note that the pathway 10-3 does not have to be prepared before a failure occurs. However, the pathway 10-3 may be prepared before a failure occurs; in this case, an uninterrupted redundant configuration can be rapidly constructed in the event that a failure occurs. Note that, when the signals 1 and 2 transmitted through the pathways 10-1 to 10-n are optical signals, optical fibers are used for the pathways 10-1 to 10-n.

The receivers 106 and 107 receive the signals 1 and 2, monitor and compare the quality of the signals 1 and 2. Then the receivers 106 and 107 output the signal having the better quality to the client device 111. A transmission delay difference due to a pathway distance difference occurs in the signals 1 and 2 received by the receivers 106 and 107, shifting the phases of the signals. In this state where the signal phases shift, signal data drop (bit drop) occurs at the time of redundant switching. In order to avoid this problem, the receivers 106 and 107 detect the phase difference up to arrival based on the counter numbers added by the transmitters 104 and 105. Then the receivers 106 and 107 perform phase adjustment of the signals in the memory in the receivers 106 and 107 so that the counter numbers become identical. Performing phase adjustment of the signals eliminates signal data drop (bit drop) at the time of redundant switching, and allows uninterrupted pathway switching. As just described, in the event that a failure occurs in the active pathway, a new pathway 10-3 is searched for, the counter number of the new pathway 10-3 is compared with that of a survival pathway, and the phase adjustment is performed. Note that in the event that a failure occurs in the pathway 10-1, the redundant switch destination pathway 10-2 becomes a survival pathway. The phase adjustment of the present exemplary embodiment is performed on the side of the new redundant switching pathway 10-3, not on the side of the survival pathway 10-2, in order not to influence the signal of the survival pathway 10-2. This allows the signal sent to the client device 111 not to be influenced by the phase adjustment. Note that various types of configuration and means may be used for the comparison of the quality of the signals at the receivers 106 and 107. For example, the receivers 106 and 107 may communicate with each other to compare the quality of the signals, or the quality of signals may be monitored externally by a comparator (not shown) or the like.

Note that the receivers 106 and 107 are optical receivers when the signals 1 and 2 are optical signals. The signals 1 and 2 outputted from the receivers 106 and 107 to the client device 111 may be optical signals or electrical signals. When the signals 1 and 2 are electrical signals, the receivers 106 and 107 have an optical-to-electrical conversion function. On the other hand, when the signals 1 and 2 are optical signals, the receivers 106 and 107 have a wavelength conversion function or a bit rate conversion function, as needed. For example, when WDM transmission is being performed, the receivers 106 and 107 convert the wavelength of the signal to a wavelength suitable for the client device 111. Further, when the counter number for signal phase adjustment or the overhead for monitoring is added, the counter number or the overhead is removed to reduce the bit rate, as needed. The receivers 106 and 107 output the signals 1 and 2 to the client device 111.

Note that in the redundant switching system of the present exemplary embodiment, the signals 1 and 2 may be electrical signals. In this case, each of the transmitters 104 and 105, the cross-connect devices 108 and 109, the receivers 106 and 107 is an electrical device, and the pathways 10-1 to 10-n are a coaxial cable or the like.

In this manner, in the redundant switching system of the present exemplary embodiment, uninterrupted pathway switching is achieved by matching the phases of the pathways. In the redundant switching system of the present exemplary embodiment, the signals having the same phase are outputted to the client device 111 from the receivers 106 and 107, thus allowing uninterrupted pathway switching. Note that when there is a phase difference among the pathways 10-1 to 10-n, the phase difference can be eliminated by providing a delay to the pathway that is a redundant pathway. When the phase difference between the pathways is relatively small, the phase between the pathways can be matched by performing phase adjustment in the memory in the receiver on the side of the redundant pathway. As just described, since the phase adjustment is not performed on the active pathway 10-1 and the survival pathway 10-2, the quality of the transmission can be kept. Note that various types of means can be used for a method for providing a delay. For example, a phase adjustment circuit (not shown) or the like may be preinstalled in each pathway, thus allowing the phase of each pathway to be adjusted, and a delay to be provided.

### <Processing Operation in Redundant Switching System>

Next, the processing operation of a redundant switching system of the present exemplary embodiment will be described with reference to FIGS. 2 to 4. FIG. 2 shows a normal operation condition, and a state where the redundant configuration is constructed in which the uninterrupted redundant switching is possible between the pathway 10-1 and the pathway 10-2. In an initial condition, the pathway 10-1 is selected as an active pathway, and the pathway 10-2 is selected as a redundant pathway. FIG. 3 shows a condition where a transmission path failure occurs in the pathway 10-1, and a state where the uninterrupted pathway switching from the pathway 10-1 to the pathway 10-2 is performed. FIG. 4 shows a state where the pathway 10-3 is searched for and prepared as a new redundant pathway for the pathway 10-2, and a redundant configuration is reconstructed in which uninterrupted redundant switching is possible between the pathway 10-2 and the pathway 10-3. Note that, for the sake of simplifying the description, although, in the present exemplary embodiment, the switching to the pathway 10-3 is shown, further switching to another pathway may be possible.

As shown in FIG. 2, the signal outputted from the client device 110 is branched into the signal 1 and the signal 2, and outputted to the transmitters 104 and 105. The transmitters 104 and 105 add counter numbers to the signals 1 and 2, respectively, if the counter numbers have not been added thereto. Then the transmitters 104 and 105 output the signals 1 and 2, respectively, to the cross-connect device 108. The cross-connect device 108 allocates the signals 1 and 2 to the pathways 10-1 and 10-2, respectively, and outputs the signals. The pathways 10-1 and 10-2 transmit the signals 1 and 2, respectively, and output the signals to the cross-connect device 109. The cross-connect device 109 allocates the signals 1 and 2 to the receivers 106 and 107, respectively, and outputs the signals. The receivers 106 and 107 receive the signals 1 and 2, respectively, and output one of them to the client device 111. Here, the pathway 10-1 is selected as an active pathway before a transmission path failure occurs. Therefore, the signal 1 from the receiver 106 is outputted to the client device 111, and the signal 2 from the receiver 107 is blocked. Note that the pathway 10-2, which is a redundant pathway for the active pathway 10-1, is pre-adjusted to the same phase as that of the pathway 10-1. More specifically, although the pathways 10-1 and 10-2 are selected so that they have the same phases, it is difficult to completely match the phases of the signals 1 and 2. Therefore, the receivers 106 and 107 compare the counter numbers of the signals 1 and 2, and adjust the phases of them so that the phases match. In this manner, an uninterrupted redundant configuration 112 is constructed between the pathway 10-1, which is an active pathway, and the pathway 10-2, which is a redundant pathway.

Under this condition, as shown in FIG. 3, in the event that a transmission path failure 114 occurs in the pathway 10-1, the output from the receiver 106 is blocked. Then, uninterrupted pathway switching from the pathway 10-1 to the pathway 10-2 is performed, and the signal 2 from the receiver 107 is outputted to the client device 111. In this manner, uninterrupted pathway switching from an active system to a redundant system is performed.

Next, under this condition, in order to reconstruct an uninterrupted redundant configuration, the cross-connect devices 108 and 109 search for a pathway which serves as a redundant pathway for the pathway 10-2. Then, as shown in FIG. 4, the cross-connect devices 108 and 109 prepare a new pathway 10-3 having the same phase as that of the pathway 10-2. At that time, if there is a phase difference between the pathways, a delay may be provided to the pathway 10-3 so that the pathways have the same phases. Providing a delay to the pathway 10-3 prevents the signal 2 that is being transmitted through the survival pathway (pathway 10-2) from being influenced by the addition of the delay. However, when the phase difference can be adjusted in the memory in the receiver, the phase adjustment may be performed in the receiver. The phase adjustment is performed only in the memory in the receiver 106, and is not performed in the memory in the receiver 107. This prevents the signal 2 that is being transmitted through the survival pathway (pathway 10-2) from being influenced by the phase adjustment. As described above, a new uninterrupted redundant configuration 113 is constructed between the pathways 10-2 and 10-3. However, when it is difficult to adjust the pathway 10-3 to have the same phase as that of the pathway 10-2, another pathway (10-4 to 10-n) has to be searched for to reconstruct an uninterrupted redundant configuration. As an ancillary function to this, the monitoring system 115 and the cross-connect devices 108 and 109 may acquire and store the phase information (or delay information) on the pathways 10-1 to 10-n in advance. Then, in the event that a failure occurs, the monitoring system 115 or the like refers to the delay information and selects a pathway whose phase can be adjusted. This facilitates the selection of a redundant pathway in the event that a failure occurs.

Note that, as a trigger of phase adjustment, a manual setting or an automatic setting may be considered, as described above. The receivers 106 and 107 recognize the new pathway 10-3 and perform the phase adjustment of the pathway, based on the trigger.

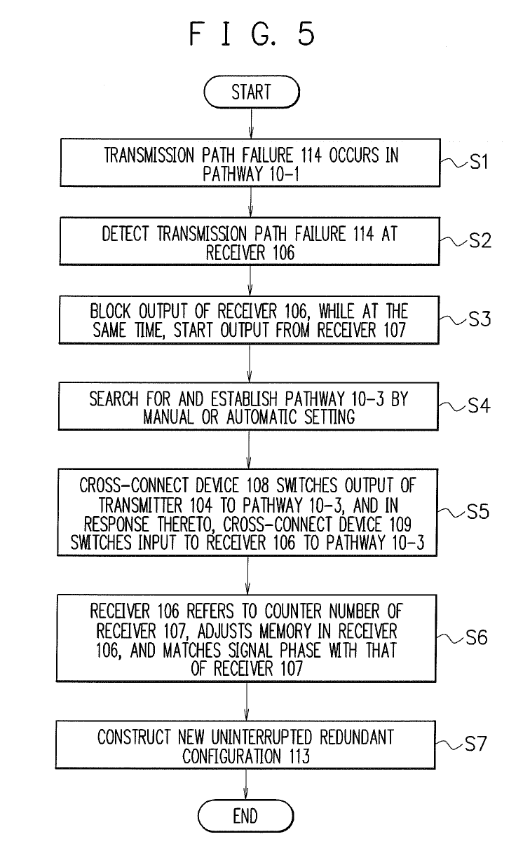

The operation from the occurrence of a transmission path failure 114 in FIG. 3 to the construction of the uninterrupted redundant configuration 113 in FIG. 4 will now be described with reference to FIG. 5.

First, the transmission path failure 114 occurs in the pathway 10-1 (step S1). The receiver 106 detects the transmission path failure 114 (step S2). The output of the receiver 106 is blocked, while at the same time, the output of the receiver 107 starts (step S3). Next, the search and setting of the pathway 10-3 is performed by a manual setting or an automatic setting (step S4). The cross-connect device 108 switches the output of the transmitter 104 to the pathway 10-3, and, in response thereto, the cross-connect device 109 switches the input to the receiver 106 to the pathway 10-3 (step S5). The receiver 106 refers to the counter number of the receiver 107, adjusts the memory in the receiver 106, and matches the signal phase with that of the receiver 107 (step S6). This allows a new uninterrupted redundant configuration 113 to be constructed (step S7).

Note that, in step S1, various types of failures can be considered for the transmission path failure 114, such as loss of signal, bit error and frame error. In addition, in step S2, the receiver 107 may not detect a transmission path failure. This is because the transmission path failure 114, which occurred in the pathway 10-1, usually does not have an impact on the pathway 10-2.

In addition, in step S3, the counter numbers of the receivers 106 and 107 are set in advance to be identical, and the signal phases of the signals 1 and 2 are synchronized. Under this condition, by switching the signal that is passed to the client device 111 from the signal 1 to the signal 2, uninterrupted pathway switching can be achieved. Further, this switching is performed by returning to an earlier counter number than the counter number at which the transmission path failure 114 was detected in step S2. This allows the switching to be performed without loss of information sent to the receivers 106 and 107.

In addition, in step S5, a new redundant pathway (pathway 10-3) does not necessarily have to be established simultaneously at the cross-connect devices 108 and 109. Further, in step S6, the phase adjustment of a signal is performed on the side of the receiver 106. This prevents the signal 2 of the survival pathway (pathway 10-2) from being influenced.

Although the operation of the preparation of the redundant pathway to the pathway 10-3 has been described, in the event that another failure occurs in the pathway 10-2, the same operation is performed to prepare a fourth pathway as a redundant pathway. At this time, if the transmission path failure 114 of the pathway 10-1 has been restored, the pathway 10-1 can be also reused as the fourth pathway. In addition, even if another failure continuously occurs, the same operation can be performed to continue to construct a new uninterrupted redundant configuration. For example, it is assumed that the active pathway was switched from the pathway 10-1 to the pathway 10-3, and the redundant pathway was switched from the pathway 10-2 to the pathway 10-4. Under this condition, in the event that further failure occurs in the pathway 10-3, the described above operation can be performed to prepare a pathway 10-5 as a new redundant pathway.

In addition, under an operation condition of FIG. 2, a case can also be considered where a failure occurs on the side of the pathway 10-2, not on the side of the pathway 10-1. Also in this case, since the uninterrupted redundant configuration 112 cannot be constructed, an operation is performed similarly to the case where a failure occurred in the pathway 10-1, allowing redundant configuration to be reconstructed. More specifically, when a failure is detected on the receiver 107, the pathway 10-3 having the same phase as that of the survival pathway 10-1 is searched for. Then, the cross-connect device 108 switches the output of the transmitter 105 to the pathway 10-3, and the cross-connect device 109 switches the input to the receiver 107 to the pathway 10-3. Finally, the receiver 107 matches the signal phase with that of the receiver 106.

In this manner, in the event that a failure occurs in a pathway, the redundant switching system 100 of the present exemplary embodiment can search for a pathway allowing new uninterrupted pathway switching, and establish a pathway to continue to construct an uninterrupted redundant configuration. In addition, the redundant switching system 100 of the present exemplary embodiment can prepare a pathway allowing uninterrupted pathway switching all the time to continue to construct an uninterrupted redundant configuration. Further, since the redundant switching system 100 of the present exemplary embodiment uses the cross-connect devices 108 and 109 for selecting a pathway, it can be achieved with a simple configuration. Moreover, the redundant switching system 100 of the present exemplary embodiment can automatically construct an uninterrupted redundant configuration when the pathway switching of the cross-connect devices 108 and 109 is performed by an automatic setting. Furthermore, since the redundant switching system 100 of the present exemplary embodiment performs phase adjustment of a signal at the pathways 10-1 to n or the receivers 106 and 107, uninterrupted pathway switching can be performed without data drop at the time of pathway switching. In addition, since the redundant switching system 100 of the present exemplary embodiment performs phase adjustment only at a redundant switching pathway that is newly provided, not at the survival pathway, it can prevent a signal transmitted to the client device 111 from being influenced.

### Second Exemplary Embodiment

Next, a second exemplary embodiment will be described.

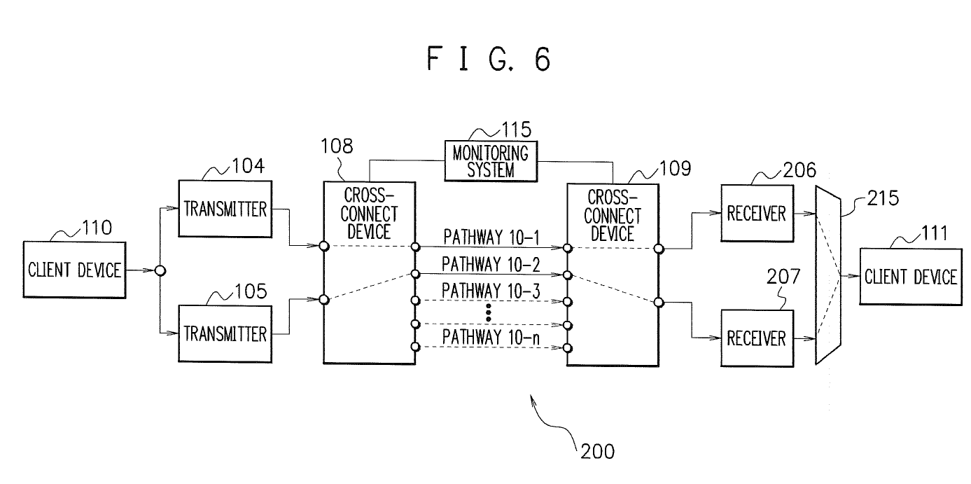

As shown in FIG. 6, a redundant switching system 200 according to the second exemplary embodiment includes a selector 215 for outputting any of signals outputted from the receivers 206 and 207 to the client device 111. This allows the same processing as that of the redundant switching system 100 of the first exemplary embodiment to be performed. The redundant switching system 200 of the second exemplary embodiment will be described below with reference to FIG. 6.

FIG. 6 is a diagram showing an example of system configuration of the redundant switching system 200 according to the second exemplary embodiment. The redundant switching system 200 according to the second exemplary embodiment includes the selector 215 when compared with the redundant switching system 100 of the first exemplary embodiment. Note that the identical symbols are assigned to the identical configuration in FIG. 1, and the description of them will be omitted.

The selector 215 receives the signals 1 and 2 having the same phase from the receivers 206 and 207. Then, the selector compares the signals 1 and 2, selects the signal having the better quality, and sends the signal to the client device 111.

Although, in the first exemplary embodiment, the receivers 106 and 107 compare the reception quality of the signals, and output the signal having the better quality to the client device 111, in the second exemplary embodiment, the selector 215 outputs the signal having the better equality to the client device 111. Therefore, the receivers 206 and 207 of the second exemplary embodiment do not have to have a function for communicating with each other to compare the quality of the signals as in the first exemplary embodiment. Note that the redundant switching system 200 of the second exemplary embodiment brings about the same effect as that of the first exemplary embodiment.

Note that the above described exemplary embodiment is a preferred embodiment of the present invention, and the scope of the present invention is not limited to the above exemplary embodiment, therefore, one of ordinary skill in the art may modify and substitute the above exemplary embodiment to construct an embodiment where various changes are made without departing from the spirit of the present invention.

For example, control operation in each device that comprises the redundant switching system in the above described present exemplary embodiment can be performed using hardware, software, or a combination of them.

Note that, when the processing is performed using software, a program on which a processing sequence is recorded can be installed and executed in the memory in a computer, which is embedded in dedicated hardware. Alternatively, the program can be installed and executed in a general-purpose computer capable of performing various types of processing.

For example, such a program may be recorded in advance in a hard disk and Read Only Memory (ROM) serving as a recording medium. Alternatively, the program may be stored (recorded) in a removable recording medium temporarily or permanently. Such a removable recording medium can be provided as so-called package software. Note that a removable recording medium includes a floppy™ disk, a Compact Disc Read Only Memory (CD-ROM), a Magneto optical (MO) disk, a Digital Versatile Disc (DVD), a magnetic disk and semiconductor memory and the like.

Note that a program is installed from the above described removable recording medium onto a computer. A program is also wirelessly transferred from a download site to a computer. Further, a program is transferred over a wire to a computer through a network.

In addition, the redundant switching system not only can be executed in time series according to the processing operation described in the above embodiment, it can also be constructed so as to be executed in parallel or individually, as needed, depending on the processing capability of the device executing the processing.

In addition, the redundant switching system may be constructed so as to include a configuration in which a plurality of devices are logically grouped, or a configuration in which each device of the configuration exists within the same enclosure.

In view of the above described embodiments, the present invention has the following characteristics.

A redundant switching system according to the present invention, which is a redundant switching system in a transmission system, may comprise two pathways that construct an uninterrupted redundant configuration and allow uninterrupted pathway switching, wherein in the event that a failure occurs in either of the two pathways, the system prepares another pathway allowing uninterrupted pathway switching for the pathway where a failure did not occur to reconstruct an uninterrupted redundant configuration by means of the pathway where a failure did not occur, and the other pathway.

Further, a redundant switching system according to the present invention, which is a redundant switching system in a transmission system, may comprise a first pathway for transmitting a first signal, and a second pathway that allows uninterrupted pathway switching for the first pathway and transmits a second signal having the same information as that of the first signal, wherein in the event that a failure occurs in the first pathway, the system performs uninterrupted pathway switching to the second pathway, and prepares a third pathway allowing uninterrupted pathway switching for the second pathway.

Further, a redundant switching system according to the present invention, which is a redundant switching system in a transmission system, may comprise a first sending unit which sends a first signal, a first pathway which transmits the first signal, a first receiving unit which receives the first signal, a second sending unit which sends a second signal having the same information as that of the first signal, a second pathway which transmits the second signal, a second receiving unit which receives the second signal, a first cross-connect unit which transfers the first signal from the first sending unit to the first pathway, and transferring the second signal from the second sending unit to the second pathway, a second cross-connect unit which transfers the first signal from the first pathway to the first receiving unit, and transferring the second signal from the second pathway to the second receiving unit, and, in the event that a failure occurs in the first pathway, preparing a third pathway allowing uninterrupted pathway switching for the second pathway, wherein the first cross-connect unit switches the transfer destination of the first signal from the first pathway to the third pathway, and the second cross-connect unit switches the transfer source of the first signal from the first pathway to the third pathway.

Further, the redundant switching method according to the present invention, which is a redundant switching method in a transmission system, may comprise constructing an uninterrupted redundant configuration by means of two pathways that allow uninterrupted pathway switching, and, in the event that a failure occurs in either of the two pathways, preparing another pathway allowing uninterrupted pathway switching for the pathway where a failure did not occur to reconstruct an uninterrupted redundant configuration by means of the pathway where a failure did not occur, and the other pathway.

Further, the redundant switching method according to the present invention, which is a redundant switching method in a transmission system, may comprise transmitting a first signal through a first pathway, transmitting a second signal having the same information as that of the first signal through a second pathway allowing uninterrupted pathway switching for the first pathway, retaining uninterrupted redundancy by means of the first signal received through the first pathway, and the second signal received through the second pathway, in the event that a failure occurs in the first pathway, searching for and preparing a third pathway allowing uninterrupted pathway switching for the second pathway, transmitting the second signal through the second pathway, transmitting the first signal through the third pathway instead of the second pathway, and restoring retention of the uninterrupted redundancy by means of the second signal received from the second pathway and the first signal received from the third pathway.

According to the present invention, an effect of maintaining an uninterrupted redundant configuration can be provided. This is because, even in the event that a failure occurs in any of pathways where a redundant configuration is constructed, another pathway allowing uninterrupted pathway switching for a pathway where a failure did not occur is searched for and prepared, and the redundant configuration is reconstructed by means of the pathway where a failure did not occur, and the other pathway.

Note that the redundant switching system, the redundant switching method and the recording medium according to the present invention can be applied to various types of transmission systems, for example, WDM, SONET, SDH and MPLS networks and the like.

While the invention has been particularly shown and described with reference to exemplary embodiments thereof, the invention is not limited to these embodiments. It will be understood by those of ordinary skill in the art that various changes in form and details may be made therein without departing form the spirit and scope of the present invention as defined by the claims.

What is claimed is:

1. A redundant switching system, comprising
at least two pathways that construct an uninterrupted redundant configuration, and allow uninterrupted pathway switching,
wherein in the event that a failure occurs in either of the two pathways, the system
prepares another pathway allowing uninterrupted pathway switching for a pathway where a failure did not occur
and reconstructs an uninterrupted redundant configuration by means of the pathway where a failure did not occur and the other pathway.

2. The redundant switching system according to claim 1,
in the event that another failure occurs in any of pathways, preparing a still another pathway allowing uninterrupted pathway switching for the pathway where a failure did not occur, and
maintaining an uninterrupted redundant configuration by means of the pathway where a failure did not occur and the other pathway.

3. A redundant switching system, comprising at least
a first pathway for transmitting a first signal, and
a second pathway that allows uninterrupted pathway switching for the first pathway, and transmits a second signal that contains the same information as that of the first signal,
wherein in the event that a failure occurs in the first pathway, the system performs uninterrupted pathway switching to the second pathway, and prepares a third pathway allowing uninterrupted pathway switching for the second pathway.

4. The redundant switching system according to claim 3, comprising
a cross-connect unit
wherein, in the event that a failure occurs in the first pathway, the cross-connect unit switches the first pathway to the second pathway, and prepares the third pathway so as to allow uninterrupted pathway switching for the second pathway.

5. The redundant switching system according to claim 4, wherein
the cross-connect unit prepares a pathway for transmitting the first signal and a pathway for transmitting the second signal even if a failure occurs in any of pathways, and constructs an uninterrupted redundant configuration.

6. The redundant switching system according to claim 3, comprising
a sending-side first cross-connect unit and a receiving-side second cross-connect unit which select a pathway for transmitting the first signal and a pathway for transmitting the second signal, respectively, from the first pathway, the second pathway and the third pathway.

7. The redundant switching system according to claim 6,
in the event that a failure occurs in the first pathway,
searching for a third pathway allowing uninterrupted pathway switching for the second pathway,
wherein the first cross-connect unit switches a transmission destination of the first signal from the first pathway to the third pathway, and
the second cross-connect unit switches a transmission source of the first signal from the first pathway to the third pathway.

8. The redundant switching system according to claim 4, wherein the cross-connect unit is an optical cross-connect unit.

9. The redundant switching system according to claim 3, preparing the third pathway without influencing the second pathway.

10. The redundant switching system according to claim 7,
in the event that a failure occurs in the second pathway, not in the first pathway,
searching for a third pathway allowing uninterrupted pathway switching for the first pathway,
wherein the first cross-connect unit switches a transmission destination of the second signal from the second pathway to the third pathway, and
the second cross-connect unit switches a transmission source of the second signal from the second pathway to the third pathway.

11. The redundant switching system according to claim 7,
in the event that a failure occurs in the first pathway, and another failure occurs in the second pathway,
searching for a fourth pathway allowing uninterrupted pathway switching for the third pathway,
wherein the first cross-connect unit switches a transmission destination of the second signal from the second pathway to the fourth pathway, and
the second cross-connect unit switches a transmission source of the second signal from the second pathway to the fourth pathway.

12. The redundant switching system according to claim 1, wherein the uninterrupted pathway switching matches phases of the pathways with each other.

13. The redundant switching system according to claim 12, wherein the phase matching adjusts a phase of the pathway on a new redundant pathway side.

14. The redundant switching system according to claim 12, wherein the phase matching compares counter numbers added to the first and second signals, and adjusts the counter number of the first signal and the counter number of the second signal so that the counter numbers are equal.

15. The redundant switching system according to claim 1, comprising
a monitoring unit,
wherein the monitoring unit stores phase information on each pathway, and
in the event that a failure occurs in any of pathways, the monitoring unit refers to the phase information, and selects and prepares a pathway to be a new redundant pathway.

16. The redundant switching system according to claim 1, wherein the switching is performed by an automatic setting.

17. The redundant switching system according to claim 16, wherein the automatic setting is performed by at least one of Generalized Multi Protocol Label Switching (GMPLS) and Multi Protocol Label Switching (MPLS).

18. The redundant switching system according to claim 1, wherein optical transmission is performed in the redundant switching system.

19. A redundant switching method in a transmission system, comprising:
constructing an uninterrupted redundant configuration by means of two pathways allowing uninterrupted pathway switching; and
in the event that a failure occurs in either of the two pathways,
preparing another pathway allowing uninterrupted pathway switching for a pathway where a failure did not occur to reconstruct an uninterrupted redundant configuration by means of the pathway where a failure did not occur and the other pathway.

20. The redundant switching method according to claim 19, comprising:
in the event that another failure occurs in any of pathways, preparing a still another pathway allowing uninterrupted pathway switching for the pathway where a failure did not occur; and
maintaining an uninterrupted redundant configuration by means of the pathway where a failure did not occur and the other pathway.

21. A redundant switching method in a transmission system, comprising:
transmitting a first signal through a first pathway;
transmitting a second signal that contains the same information as that of the first signal through a second pathway allowing uninterrupted pathway switching for the first pathway;
retaining uninterrupted redundancy by means of the first signal received through the first pathway and the second signal received through the second pathway;
in the event that a failure occurs in the first pathway,
preparing a third pathway allowing uninterrupted pathway switching for the second pathway;
transmitting the second signal through the second pathway;
transmitting the first signal through the third pathway instead of the second pathway; and
restoring retention of uninterrupted redundancy by means of the second signal received from the second pathway and the first signal received from the third pathway.

22. The redundant switching method according to claim 21, comprising preparing the third pathway without influencing the second pathway.

23. A computer readable recording medium on which a redundant switching program is recorded in a transmission system, causing a computer to
construct an uninterrupted redundant configuration by means of two pathways allowing uninterrupted pathway switching, and
in the event that a failure occurs in either of the two pathways,
prepare another pathway allowing uninterrupted pathway switching for pathway where a failure did not occur to reconstruct an uninterrupted redundant configuration by means of the pathway where a failure did not occur and the other pathway.

24. The recording medium on which a redundant switching program is recorded according to claim 23, causing a computer to
in the event that another failure occurs in any of pathways, prepare a still another pathway allowing uninterrupted pathway switching for the pathway where a failure did not occur, and
maintain an uninterrupted redundant configuration by means of the pathway where a failure did not occur and the other pathway.
